(19) United States
(12) Patent Application Publication
(10) Pub. No.: US 2011/0063166 A1
(43) Pub. Date: Mar. 17, 2011

(54) Positioning Data Producing Unit and Position Tracking Device

(75) Inventor: Pao-Lin Guo, TaiChung City (TW)

(73) Assignee: GTA ELECTRONICS CO., LTD., Taipei Hsien (TW)

(21) Appl. No.: 12/558,862

(22) Filed: Sep. 14, 2009

(51) Int. Cl. G01S 19/49; G01S 19/09

(52) U.S. Cl. 342/357.32; 342/357.46

(57) ABSTRACT

A positioning data producing unit can select suitable region position units automatically in accordance with the environmental conditions of the moving target. The location information of a position tracking device is calculated either from a coordinate data of a narrow region and a position data of the narrow region which is selected in accordance with a location of the position tracking device, or from a position data of a broad region, wherein the position data of the narrow region is calculated from a movement parameter of the position tracking device, the position data of the broad region is calculated from a plurality of received satellite signals. The location information is then transmitted via a communication module to a far end receiver.

### FIELD OF THE INVENTION

The present invention relates to a positioning data producing unit and a position tracking device, and more particularly to the positioning data producing unit and the position tracking device that are capable of tracking a moving object globally including regions which are difficult to receive GPS signals.

### BACKGROUND OF THE INVENTION

In recent years, our society has increasingly replied on the electronic products, such as computers, televisions, global position system (GPS) devices, cellular phones, personal digital assistant (PDA) and monitors, in our life. With the increasing demands of GPS system due to its popularity and success, various techniques have been developed to increase the utility and conveniences of the GPS applications in different areas. The popularity of GPS applications is due to its satellite-based navigation system that can continuously transmit data of satellite position information, timing and frequency to the potential users. The GPS signal contains timing information that allows a user to determine the time elapsed for the GPS signal to transverse the distance between the GPS satellite and a receiver receiving the signal. By knowing the time the GPS signal left GPS satellite, the time the GPS signal arrived at the user, and the speed of the GPS signal, the receiver (monitor) can determine the distance from itself to the GPS satellite and the exact location of the monitored object.

When the GPS application is used to track a moving target, the positioning module is incorporated with the communication module to act as the GPS position tracking device so that the momentary location of the moving target is received constantly to locate the target's position. As a result, this kind of GPS position tracking device can be used to either monitor the moving vehicles or track the movement of persons. The location information of the moving target is produced through the position module and is transmitted to a far end receiver via the communication module, which is normally a station. The location information is sequentially transmitted from the station to a far end control centre so that the momentary location information of the moving target can be monitored constantly by the far end control centre. Therefore, whether the position module can accurately produce the location information of the moving target is directly related to whether the position tracking device can be operated effectively or not.

The conventional GPS position tracking devices have difficulty to provide accurate location information of the moving target when the target enters to regions or areas that are difficult to receiving the satellite signals, such as the underground regions or indoor areas which will prevent the receiver of the position tracking device from receiving the satellite signals properly from the GPS satellite. Therefore, the conventional GPS position tracking device requires the outdoor areas that can receive the satellite signals properly to be functioned effectively. When the target moves and stays into those areas that satellite signals are too weak to be received by the receiver of the position tracking device for a certain period of time, the position tracking process of the moving target will be forced to halt as its location information is undetectable by the position tracking device. As a result, the conventional GPS position tracking device cannot accurately locate the moving target when the target moves into the areas in which the satellite signals are unable to be received by the receiver. Further, the conventional GPS position tracking device will continuously search the satellite even when its receiver cannot detect the satellite signals, unless it is powered off manually. This kind of position tracking device will waste a lot unnecessary electrical energy on its already limited energy carrier which is specifically designed to be portable and compact so that the tracking device is light to carry.

### SUMMARY OF THE INVENTION

Therefore, it is a primary objective of the present invention to provide a position tracking device that is capable of tracking a moving target at any region, such as the indoor areas or the underground areas. It is another objective of the present invention to provide a GPS position tracking device that can track the positions of a moving target effectively when the target enters the regions, which are difficult to receive the satellite signals. It is another objective of the present invention to provide a GPS position tracking device comprising a positioning data producing unit that is capable of producing the required position data of a moving target for tracking purpose.

The present invention provide a positioning data producing unit installed in an electronic device, wherein the position data producing unit comprises a narrow region position unit, capable for producing a position data for a narrow region by detecting a movement parameter of the electronic device, and a broad region position unit, capable for producing a position data for a broad region by receiving a plurality of satellite signals.

The positioning data producing unit further comprises a switch unit, which is electrically connected to the narrow region position unit and the broad region position unit. The switch unit selects and switches between the narrow region position unit and the broad region position unit in accordance with a location of the electronic device, wherein the location information of the narrow region is calculated by the narrow region position unit in accordance with a coordinate data of the narrow region, or the location information of the broad region is calculated by the broad region position unit; when the electronic device enters the narrow region, the switch unit will calculate the location information of the narrow region via the narrow region position unit, and when the electronic device leaves the narrow region, the switch unit will calculate the location information of the broad region via the broad region position unit.

The narrow region further comprises a special region, and the switch unit switches off the function of the broad region position unit when the narrow region position unit is operating, or the switch unit switches off the function of the narrow region position unit when the broad region position unit is operating.

According to one of preferred embodiments of the present invention, the narrow region position unit further comprises a speed sensor, for detecting moving speed of the electronic device, and a direction sensor, for determining moving direction of the electronic device, wherein the movement parameter of the electronic device comprises the moving speed and moving direction of the electronic device. The positioning data producing unit comprises a memory electrically connected to the switch unit for storing the coordinate data. Or the switch unit comprises a memory region to store coordinate data.

A position tracking device in accordance with another preferred embodiment of the present invention is used for transmitting location information to a far end receiver, wherein the position tracking device comprises a positioning data producing unit and a communication module. The location information is calculated either from a coordinate data of a narrow region and a position data of the narrow region which is selected in accordance with a location of the position tracking device, or from a position data of a broad region, wherein the position data of the narrow region is calculated from a movement parameter of the position tracking device, and the position data of the broad region is calculated from a plurality of received satellite signals. The communication module is electrically connected to the positioning data producing unit for transmitting the location information to the far end receiver; when the position tracking device enters the narrow region, the positioning data producing unit will calculate the location information through the position data of the narrow region, and when the position tracking device leaves the narrow region, the positioning data producing unit will calculate the location information through the position data of the broad region. The narrow region in accordance with this preferred embodiment of the present invention further comprises a special region.

According to another preferred embodiment of the present invention, the communication module is selected from one of modules of GSM (Global System for Mobile communication) communication, CDMA (Code Division Multiple Access) communication, W-CDMA (Wideband-Code Division Multiple Access) communication or other wireless communication modules.

A pre-determined value of the movement parameters is set by the positioning data producing unit in accordance with another preferred embodiment of the present invention, wherein the pre-determined value is used as the control guidance for accidental situation, when the movement parameters of the position tracking device exceed the pre-determined value, the location information of the position tracking device is determined and sent to the far end receiver via the communication module to indicate that the target which is in an accidental condition, is either fall or being hit.

The present invention provides a position tracking device that capable of switching off when the narrow region position unit is operating in order to utilize the power effectively by cutting unnecessary operations. The positioning data producing unit shuts down the function of the broad region position unit when the narrow region position unit is operating. Or the positioning data producing unit shuts down the function of the narrow region position unit when the broad region position unit is operating. Thus, the present invention provides a position tracking device that can save a lot of unnecessary energy when the satellite signal is difficult to be detected. The present invention utilizes the positioning data producing unit in the position tracking device together with the design of the switch unit to provide an effective position tracking operation.

### BRIEF DESCRIPTION OF THE DRAWINGS

FIG. 1 is a flow diagram of a positioning data producing unit in accordance with a preferred embodiment of the present invention;

FIG. 2 is a flow diagram of the positioning data producing unit in accordance with another preferred embodiment of the present invention;

FIG. 3 is a flow diagram of a position tracking device and the positioning data producing unit in accordance with another preferred embodiment of the present invention; and

FIG. 4 is a partial flow diagram for transmitting location information of the position tracking device in accordance with another preferred embodiment of the present invention.

### DESCRIPTION OF THE PREFERRED EMBODIMENT

The present invention provides a position tracking device that can detect the movement of a moving target regionally by dividing the regions into narrow and broad regions, in which the narrow region comprises a special region and the broad region comprises the narrow region. The region selection is based upon the places visited frequently by the target, and if some of regions are indoor places, or underground passages wherein the satellite signal is too weak to be detected that can result the tracking process of the target's position difficult to be carried out properly such as, the receiver of the position tracking device cannot detect or receive the transmitted satellite signal. These regions will then be destined as the narrow regions in accordance with a preferred embodiment of the present invention. In other words, the position tracking device of the present invention distinguishes and categories those frequent visited regions such as, the indoor or underground places with low or weak satellite signals as the narrow region, which indicates as the special region with the fixed coordinates in which are pre-determined and stored in the device so that those coordinates data can be incorporated with the movement parameter to locate the momentary positions of the moving target.

For example, a patient frequently travels in between the hospital and his home, the hospital and his home will be categorized as the narrow region which will include those regions along his travel path that consists of underground passages or underground transportation difficult to receive the wireless satellite signals. Sine the narrow region is considered as the special region, the coordinate data of the patient in the narrow region will be pre-determined and stored in the position tracking device in such that when the moving target enters the narrow region, the pre-stored coordinate data of the moving target will be provided to incorporate with the movement parameter for calculating the required location information of the moving target.

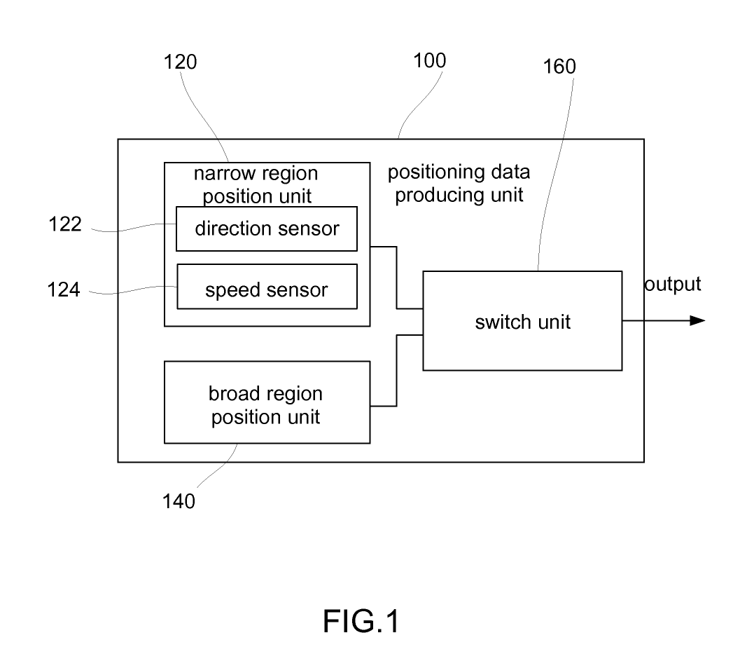

With reference to FIG. 1 for a flow diagram of a positioning data producing unit in accordance with one of preferred embodiments of the present invention, the positioning data producing unit 100 is installed in an electronic device to calculate the positioning data of the electronic device, wherein the positioning data producing unit 100 comprises a narrow region position unit 120, a broad region position unit 140 and a switch unit 160. The narrow region position unit 120 produces positioning coordinates of a narrow region (special region). The broad region position unit 140 produces positioning coordinates of a broad region (including all tracking regions). The switch unit 160 is electrically connected to the narrow region position unit 120 and the broad region position unit 140 in order to receive the output from the two region position units 120 & 140. The output data from the narrow region position unit 120 and the broad region position unit 140 allows the dynamic calculation to be accurately determined by the switch unit 160, in which the outputted data of the narrow region position unit 120 (signals which are difficult to be tracked by the Global Positioning System) are then calculated by the switch unit 160. The non-narrow regions are classified as the broad regions and the outputted data are calculated by the switch unit 160 for the existing location coordinates.

The narrow region position unit 120 of the present invention is utilized to detect the movement parameter of the electronic device and produce a position coordinate of the narrow region for the estimated position calculation of the switch unit 160. The switch unit 160 is capable to determine an estimated position of the electronic device in accordance with the movement parameter of the electronic device.

The broad region position unit 140 in accordance with the preferred embodiment of the present invention is a GPS positioning unit that can perform the GPS location tracking. The broad region position data is produced by utilizing a plurality of satellite signals via the broad region position unit 140. The present invention determines the positioning coordinates of the moving target by using the strength of signals as the index to calculate the estimated distance of the position coordinates.

The switch unit 160 selects and switches between the narrow region position unit 120 and the broad region position unit 140 in accordance with the position selections of the electronic device. The location information is calculated from the coordinate data of the narrow region and the narrow region position data. The location information also can be calculated from the broad region position data. The switch unit 160 is a microprocessor with a memory region to store the tracking programs and coordinate data needed for the determination of the GPS track record of a moving target. It is well known in the art that a processor without the memory region can also be used as the switch unit 160 by incorporating an external memory to the tracking device to store the operating programs and coordinates data of the narrow region.

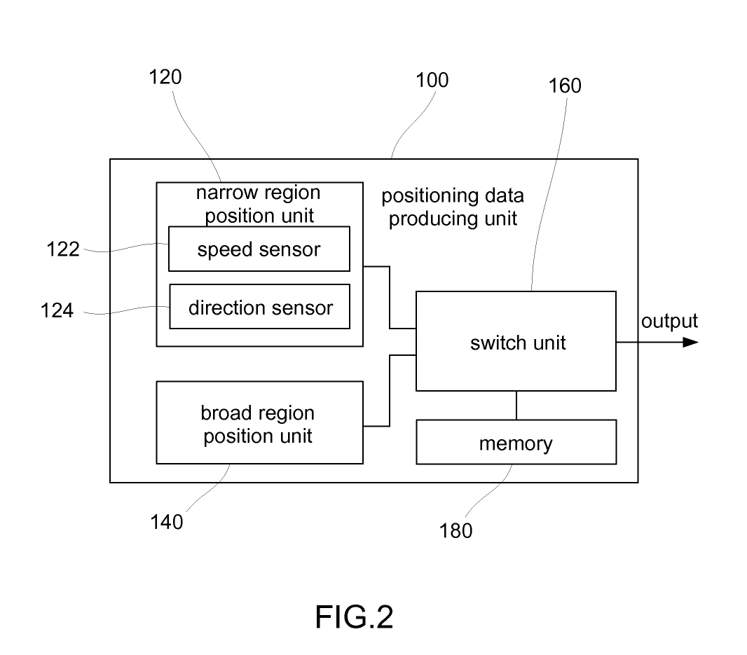

With reference to FIG. 2 for a flow diagram of the positioning data producing unit 100 in accordance with another preferred embodiment of the present invention. The narrow region position unit 120 comprises a speed sensor 122 and direction sensor 124, wherein the speed sensor 122 detects the acceleration or deceleration (speed) of the electronic device, and the direction sensor 124 detects the travel direction of the electronic device. The speed and the direction of travel are calculated to form parts of the movement parameters of the electronic device where the GPS coordinates are employed. From the calculated traveling speed and direction of the electronic device, the switch unit 160 can determine the distance of the movements, in which the coordinate data of the narrow region are calculated into coordinate points to determine the current position of the electronic device. The speed sensor 122 can be an acceleration sensor and the direction sensor can be a magnetic direction sensor.

When the electronic device enters the pre-determined narrow region, the switch unit 160 calculates the location information from the coordinate data of the broad region, and this new calculated location information will be very close to the stored coordinate data of the memory. The new calculated location information will be overlapped with the stored coordinate data when the electronic device enters the pre-determined narrow region, the switch unit 160 will then proceed the calculation of the extract location of the electronic device by incorporating the data of the new calculated location information and the stored coordinate data of the narrow region. The pre-determined narrow region can be defined to be larger than the actual narrow area in such that the switch unit 160 can operate steadily the determination function of the GPS location data and the switch function between the narrow and broad regions.

FIG. 2 shows that the memory 180 is provided and electrically connected to the switch unit 160 in the positioning data producing unit 100, wherein the memory is used to store the tracking programs and coordinates data of the narrow region needed for determining the GPS track record of a moving object. The memory 180 is the microprocessor having the memory region.

In order to increase the performance efficiency, the switch unit 160 switches to the narrow region position unit 120 simultaneously closes the broad region position unit 140 to prevent unnecessary power wasted on GPS searching and tracking in the broad region position unit 140.

The switch unit 160 can be integrally connected with the broad region position unit 140 to form as one unit for operating the switching and calculation functions, wherein the switch unit 160 can be combined with a communication module to function.

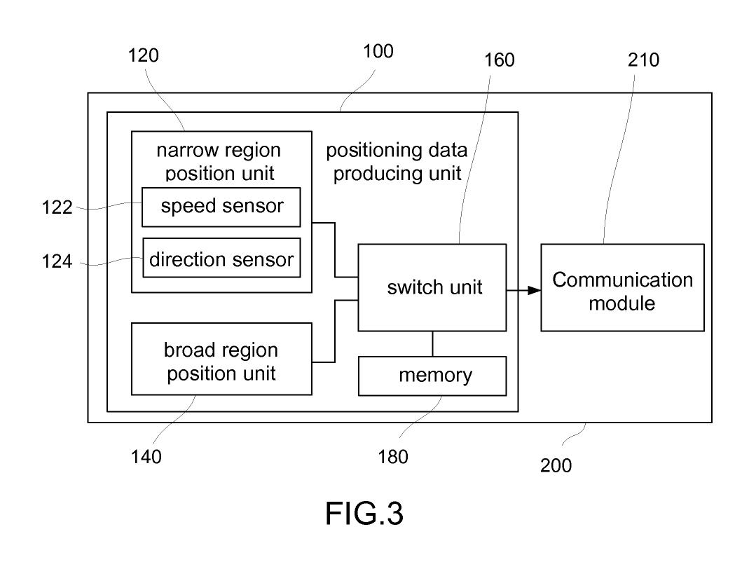

With FIG. 3 for a flow diagram of the positioning data producing unit 100 in accordance with another preferred embodiment of the present invention. A position tracking device 200 comprises a positioning data producing unit 100 and a communication module 210 for transmitting location information to another end. The positioning data producing unit 100 calculates and produces a position data in accordance with a combination of the position data of the narrow region selected by the position tracking device 200 and the coordinate data. The positioning data producing unit 100 can calculate the position data using the position data from the broad region. The position data of the narrow region is calculated from a movement parameter of the position tracking device 200, and the position data of the broad region is produced from the received plurality of satellite signals. The positioning data producing unit 100 can determine the location information via the position data from the narrow region and the position data from the broad region. The narrow region position unit 120 utilizes the speed sensor 122 and the direction sensor 124 to produce the movement parameters.

The position tracking device 200 transmits the location information to a far end receiver in which the far end receiver comprises a monitoring end or a station. When the station is used as the far end receiver, the location information is transmitted via the station to one end of the monitor. The communication module 210 can be either a GSM (Global System for Mobile communication) communication, CDMA (Code Division Multiple Access) communication, W-CDMA (Wideband-Code Division Multiple Access) communication or other wireless communication modules to transmit the location information is to one end of the monitor. When the communication module 210 is a wireless communication module, the monitor can directly receive the location information via the wireless method.

The position tracking device 200 utilizes the movement parameters to set up an emergency condition alarm system in accordance with another preferred embodiment of the present invention in such that a pre-determined value is used as a control guidance for monitoring the accidental situation so that when a target fells or is injured, the emergency condition alarm system is triggered, and the location information of the moving target is sent via the communication module 210 to the far end receiver immediately. Once the emergency condition alarm system is triggered, the narrow region position unit will not be switched off by the switch unit 160 and will monitor repeatedly the exact position of the target and produce the required movement parameters.

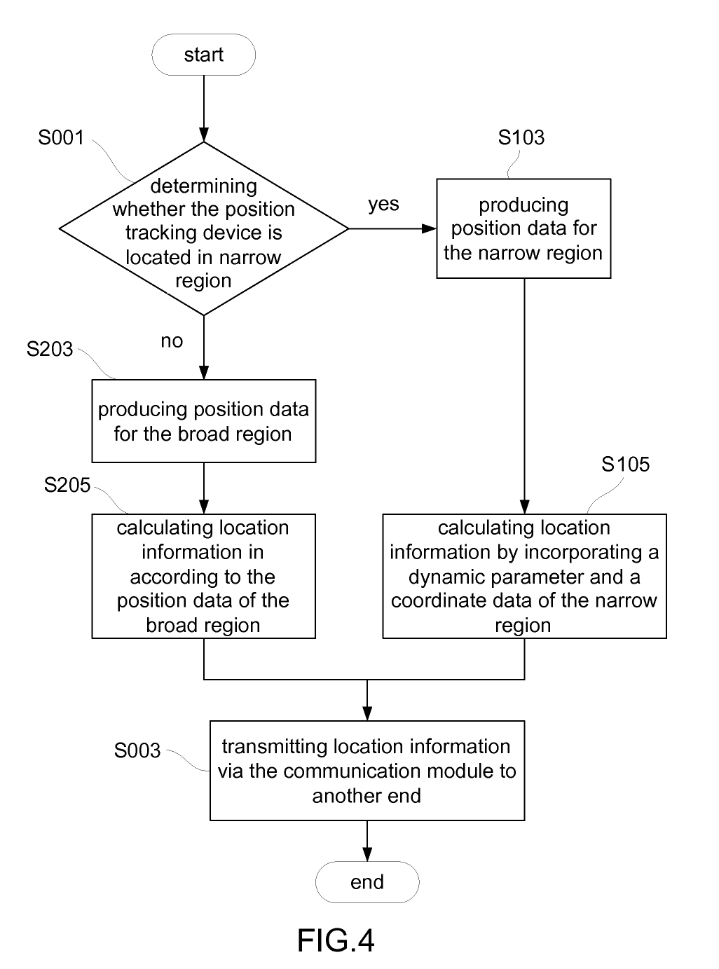

FIG. 4 shows a partial flow diagram for transmitting location information of the position tracking device in accordance with another preferred embodiment of the present invention. Since the moving target can be monitored its positions repeatedly, therefore, the transmitting procedure is carried out repeatedly in the position tracking device 200. When the monitoring process of the device is initiated, step S001, the system first determines whether the position tracking device 200 is located in the narrow region, if the position tracking device 200 is located in the narrow region, the process will proceed to step S103, in which a position data of the narrow region is produced in the step S103, and then the process will proceed sequentially to step S105, where a location information is calculated from the characteristic property combination of the coordinate data of the narrow region and the movement parameter. When the position tracking device 200 is not located in the narrow region, the process will proceed to step S203, wherein a position data for the broad region is produced and the process will proceed to step S205, where a location information is calculated from the position data of the broad region. The location information will then be transmitted to the far end receiver via the communication module 210.

The positioning data producing unit and the position tracking device of the present invention can select suitable region position units automatically in accordance with the environmental and circumstantial conditions. For example, when an area that is difficult to receive the satellite signal will be classified as the narrow region, and the coordinate data of the narrow region is determined by the narrow region position unit 120. On the other hand, the outdoor area with good reception of satellite signals will be classified as the broad region, in which its coordinate data is determined by the broad region position unit 140. Therefore, the position tracking device of the present invention can cover different tracking regions of the moving target. Furthermore, the broad region position unit 140 can be switched off when the narrow region position unit 120 is operating in order to utilize the power effectively by cutting unnecessary operations. The movement parameters obtained from the narrow region position unit 120 can be used as the control guidance for detecting accidental situation of the monitored target. The position tracking device 200 of the present invention can be applied in the mobile phones, personal digital Assistant (PDA), GPS electronic devices, in the motor vehicles, or small defecting or tracking devices.

The above-mentioned tracking position process can be written as the computer software for executing the process easily. The tacking software can be stored in any type of microprocessor that capable of determining and reading the data stored in the memory or the data related to the record media or devices. In other words, the present invention is not limited to any form of media or any type of devices, a RAM (Random-access memory) can be used as the memory region for the microprocessor, or the IC (Integrated circuit) chip, CD (Compact Disc), CD-R (Compact Disc-Recordable), MO (Magneto-Optical) disc, hardware disc, software disc or other kinds of media recorders with similar functions, can all be used in the present invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A positioning data producing unit, installed in an electronic device, comprising:
a narrow region position unit, capable for producing a position data for a narrow region by detecting a movement parameter of the electronic device;
a broad region position unit, capable for producing a position data for a broad region by receiving a plurality of satellite signals; and
a switch unit, electrically connected to the narrow region position unit and the broad region position unit, wherein the switch unit selects and switches between the narrow region position unit and the broad region position unit in accordance with a location of the electronic device, wherein the location of the electronic device is used to calculate a location information of the narrow region via the narrow region position unit in accordance with a coordinate data of the narrow region, or to calculate a location information of the broad region via the broad region position unit; when the electronic device enters the narrow region, the switch unit will calculate the location information of the narrow region via the narrow region position unit, and when the electronic device leaves the narrow region, the switch unit will calculate the location information of the broad region via the broad region position unit.

2. The positioning data producing unit of claim 1, wherein the narrow region position unit further comprises
a speed sensor, for detecting moving speed of the electronic device; and
a direction sensor, for determining moving direction of the electronic device; wherein the movement parameter of the electronic device comprises the moving speed and moving direction of the electronic device.

3. The positioning data producing unit of claim 2, wherein the positioning data producing unit comprises a memory which is electrically connected to the switch unit for storing the coordinate data.

4. The positioning data producing unit of claim 2, wherein the switch unit further comprises a memory region for storing the coordinate data.

5. The positioning data producing unit of claim 1, wherein the narrow region comprises a special region.

6. The positioning data producing unit of claim 1, wherein the switch unit switches off the operation of the broad region position unit when the narrow region position unit is operating.

7. The positioning data producing unit of claim 6, wherein the switch unit switches off the operation of the narrow region position unit when the broad region position unit is operating.

8. A position tracking device, capable for transmitting location information to a far end receiver, comprising:
a positioning data producing unit, wherein the location information is calculated either from a coordinate data of a narrow region and a position data of the narrow region, which is selected in accordance with a location of the position tracking device, or from a position data of a broad region, wherein the position data of the narrow region is calculated from a movement parameter of the position tracking device, the position data of the broad region is calculated from a plurality of received satellite signals; and
a communication module, electrically connected to the positioning data producing unit for transmitting the location information to the far end receiver; when the position tracking device enters the narrow region, the positioning data producing unit will calculate the location information through the position data of the narrow region, and when the position tracking device leaves the narrow region, the positioning data producing unit will calculate the location information through the position data of the broad region.

9. The position tracking device of claim 8, wherein the positioning data producing unit comprises a narrow region position unit for producing the position data for the narrow region, and a broad region position unit for producing the position data of the broad region.

10. The position tracking device of claim 9, wherein the narrow region position unit comprises
a speed sensor for detecting moving speed of the position tracking device; and
a direction sensor for detecting moving direction of the position tracking device; wherein the movement parameter of the position tracking device comprises moving speed and moving direction of the position tracking device.

11. The position tracking device of claim 9, wherein the communication module is selected from one of modules of GSM (Global System for Mobile communication) communication, CDMA (Code Division Multiple Access) communication, W-CDMA (Wideband-Code Division Multiple Access) communication, or a wireless communication

12. The position tracking device of claim 9, wherein the narrow region comprises a special region.

13. The position tracking device of claim 9, wherein the positioning data producing unit shuts down the function of the broad region position unit when the narrow region position unit is operating.

14 The position tracking device of claim 13, wherein the positioning data producing unit shuts down the function of the narrow region position unit when the broad region position unit is operating.

15. The position tracking device of claim 13, wherein the positioning data producing unit calculates the location information of the position tracking device at pre-determined time intervals.

16. The position tracking device of claim 13, wherein a pre-determined value is set by the positioning data producing unit, when the movement parameters of the position tracking device exceed the pre-determined value, the location information of the position tracking device is determined and sent to the far end receiver via the communication module.
